(19) United States
(12) Patent Application Publication
(10) Pub. No.: US 2026/0036695 A1
(43) Pub. Date: Feb. 5, 2026

(54) MEASUREMENT APPARATUS FOR MEASURING DISTANCE TO PHYSICAL OBJECT AND/OR VELOCITY OF PHYSICAL OBJECT

(71) Applicant: Panasonic Intellectual Property Management Co., Ltd., Osaka (JP)

(72) Inventors: HIROYUKI TAKAGI, Osaka (JP); YASUHISA INADA, Osaka (JP); KENJI NARUMI, Osaka (JP); KAZUYA HISADA, Nara (JP)

(21) Appl. No.: 19/353,656

(22) Filed: Oct. 9, 2025

Related U.S. Application Data
(63) Continuation of application No. PCT/JP2023/046842, filed on Dec. 27, 2023.

(30) Foreign Application Priority Data
Apr. 25, 2023 (JP) 2023-071595

(51) Int. Cl. G01S 17/58; G01S 7/481

(52) U.S. Cl. CPC G01S 17/58; G01S 7/4818

(57) ABSTRACT

A measurement apparatus includes a light source, a first splitter that divides light from the light source into irradiating light and reference light, a second splitter that divides the irradiating light into first irradiating light and second irradiating light, a first waveguide through which the first irradiating light and first reflected light reflected from a scene pass together, a second waveguide through which the second irradiating light and second reflected light reflected from the scene pass together, a third waveguide that branches off from the first waveguide and through which the first reflected light having passed through the first waveguide passes, a fourth waveguide that branches off from the second waveguide and through which the second reflected light having passed through the second waveguide passes, and a photodetector that detects the first reflected light, the second reflected light, and the reference light.

### BACKGROUND

### 1. Technical Field

The present disclosure relates to a measurement apparatus for measuring the distance to a physical object and/or the velocity of the physical object.

### 2. Description of the Related Art

A LIDAR (light detection and ranging) technology for measuring the distance to a physical object by irradiating the physical object with light and detecting reflected light from the physical object is under development. For example, a LiDAR apparatus that is capable of measuring the distance to a physical object and the velocity of the physical object by using an FMCW (frequency modulated continuous wave) technology is under development. Using the FMCW technology makes it possible to achieve both a wide dynamic range and high resolution for distance, makes it hard to be affected by disturbances, and makes it possible to detect not only the distance to but also the velocity of a moving physical object.

The LiDAR apparatus based on the FMCW technology includes, for example, a light source, a photodetector, and a processing circuit. The light source is controlled to emit light whose frequency changes with passage of time. The photodetector detects interfering light generated by interference between the reflected light from the physical object and reference light from the light source and thereby outputs a beat signal including a beat having a frequency corresponding to a time delay in the reflected light. The processing circuit computes the distance to the physical object and/or the velocity of the physical object on the basis of the frequency of the beat signal.

Japanese Unexamined Patent Application Publication (Translation of PCT Application) No. 2022-544743, U.S. Pat. No. 11,105,900, and Japanese Unexamined Patent Application Publication (Translation of PCT Application) No. 2019-522211 disclose examples of LiDAR apparatuses based on the FMCW technology.

### SUMMARY

One non-limiting and exemplary embodiment provides a measurement apparatus that makes it possible to expand a measurable distance range.

In one general aspect, the techniques disclosed here feature a measurement apparatus including a light source, a first splitter that divides light from the light source into irradiating light and reference light, a second splitter that divides the irradiating light into first irradiating light and second irradiating light, a first waveguide through which the first irradiating light and first reflected light reflected from a scene pass together, a second waveguide through which the second irradiating light and second reflected light reflected from the scene pass together, a third waveguide that branches off from the first waveguide and through which the first reflected light having passed through the first waveguide passes, a fourth waveguide that branches off from the second waveguide and through which the second reflected light having passed through the second waveguide passes, and a photodetector that detects the first reflected light, the second reflected light, and the reference light.

It should be noted that general or specific embodiments of the present disclosure may be implemented as a system, an apparatus, a method, an integrated circuit, a computer program, a computer-readable storage medium such as a storage disk, or any selective combination thereof. The computer-readable storage medium includes a nonvolatile storage medium such as a CD-ROM (compact disc read-only memory). The apparatus may be constituted by one or more apparatuses. In a case where the apparatus is constituted by two or more apparatuses, the two or more apparatuses may be placed in one piece of equipment or may be separately placed in two or more separate pieces of equipment. The term “apparatus” herein or in the claims can not only mean one apparatus but also mean a system composed of a plurality of apparatuses. The plurality of apparatuses included in the “system” can include an apparatus placed in a remote location away from another apparatus and connected via a communication network.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

A technology of the present disclosure makes it possible to expand a measurable distance range.

### BRIEF DESCRIPTION OF THE DRAWINGS

FIG. 1 is a block diagram schematically showing a configuration of an exemplary measurement apparatus according to the present disclosure;

FIG. 2A is a diagram schematically showing examples of time changes in the frequencies of reference light and reflected light in a case where a physical object is at rest;

FIG. 2B is a diagram schematically showing examples of time changes in the frequencies of the reference light and the reflected light in a case where the physical object is moving;

FIG. 3 is a flow chart schematically showing an example of a measuring operation that a processing circuit executes;

FIG. 4 is a graph showing an example of the power spectra of a beat signal;

FIG. 5 is a diagram for explaining a relationship between optical path length and beat frequency and the influence of various types of noise;

FIG. 6A is a diagram for explaining examples of various types of noise in a case where d₅=d₁+2d₂+d₄;

FIG. 6B is a diagram for explaining examples of various types of noise in a case where d₅=d₁+d₂+d₄;

FIG. 6C is a diagram for explaining examples of various types of noise in a case where d₅=d₁+d₄;

FIG. 7 is a diagram for explaining the influence of optical element noise in a case where the optical path length d₂ is brought close to 0;

FIG. 8A is a first diagram for explaining changes in the frequencies of various types of noise and a target frequency in a case where various optical path lengths are adjusted;

FIG. 8B is a second diagram for explaining changes in the frequencies of various types of noise and the target frequency in a case where various optical path lengths are adjusted;

FIG. 8C is a third diagram for explaining changes in the frequencies of various types of noise and the target frequency in a case where various optical path lengths are adjusted;

FIG. 9 is a block diagram showing a configuration of a measurement apparatus including a plurality of optical heads;

FIG. 10A is a diagram showing an example of the power spectra of beat signals obtained when both a first beam and a second beam are shone on the respective targets;

FIG. 10B is a diagram showing an example of the power spectra of beat signals obtained when both the first beam and the second beam are blocked;

FIG. 11 is a block diagram schematically showing a configuration of a measurement apparatus according to an exemplary embodiment of the present disclosure;

FIG. 12 is a diagram for explaining a relationship between optical path length and beat frequency and the influence of various types of noise;

FIG. 13A is a diagram showing an example of the power spectra of beat signals obtained when both the first beam and the second beam are shone on the respective targets;

FIG. 13B is a diagram showing an example of the power spectra of beat signals obtained when the first beam is shone on a target and the second beam is blocked;

FIG. 13C is a diagram showing an example of the power spectra of beat signals obtained when the first beam is blocked and the second beam is shone on a target;

FIG. 13D is a diagram showing an example of the power spectra of beat signals obtained when both the first beam and the second beam are blocked; and

FIG. 14 is a block diagram showing a configuration of a measurement apparatus according to a modification.

### DETAILED DESCRIPTIONS

In the present disclosure, all or some of the circuits, units, apparatuses, members, or sections or all or some of the functional blocks in the block diagrams can be implemented as one or more electronic circuits including a semiconductor device, a semiconductor integrated circuit (IC), or an LSI (large scale integration). The LSI or IC can be integrated into one chip, or also can be a combination of multiple chips. For example, functional blocks other than a storage element may be integrated into one chip. The name used here is LSI or IC, but it may also be called system LSI, VLSI (very large scale integration), or ULSI (ultra large scale integration) depending on the degree of integration. A field programmable gate array (FPGA) that can be programmed after manufacturing an LSI or an RLD (reconfigurable logic device) that allows reconfiguration of the connection or setup of circuit cells inside the LSI can be used for the same purpose.

Further, it is also possible that all or some of the functions or operations of the circuits, units, apparatuses, members, or sections are implemented by executing software. In such a case, the software is stored on one or more non-transitory storage media such as a ROM, an optical disk, or a hard disk drive, and when the software is executed by a processor, the software causes the processor together with peripheral devices to execute the functions specified in the software. A system or an apparatus may include such one or more non-transitory storage media on which the software is stored and a processor together with necessary hardware devices such as an interface.

The term “light” herein means not only visible light (with wavelengths of approximately 400 nm to approximately 700 nm) but also electromagnetic waves including ultraviolet radiation (with wavelengths of approximately 10 nm to approximately 400 nm) and infrared radiation (with wavelengths of approximately 700 nm to approximately 1 mm). The ultraviolet radiation is herein sometimes referred to as “ultraviolet light”, and the infrared radiation is herein sometimes referred to as “infrared light”.

The following describes an exemplary embodiment of the present disclosure. It should be noted that the embodiments to be described below illustrate general or specific examples. The numerical values, shapes, constituent elements, placement and topology of constituent elements, steps, orders of steps, or other features that are shown in the following embodiments are merely examples and are not intended to limit the present disclosure. Further, those of the constituent elements in the following embodiments which are not recited in an independent claim representing the most generic concept are described as optional constituent elements. Further, the drawings are schematic views and are not necessarily strict illustrations. Furthermore, in the drawings, substantially identical components are given identical reference signs, and a repeated description may be omitted or simplified.

### Example Configuration of Measurement Apparatus

First, a principle of measurement of distance or velocity by a measurement apparatus that is used in an embodiment of the present disclosure. For simplicity, an example of a configuration and operation of a measurement apparatus that emits a single light beam is described first. A configuration of a measurement apparatus that emits a plurality of light beams will be described later.

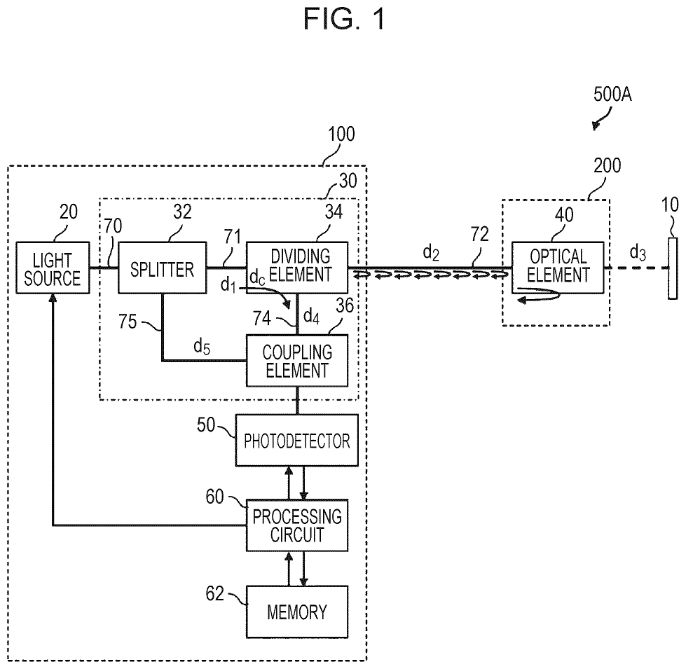

FIG. 1 is a block diagram schematically showing a configuration of an exemplary measurement apparatus 500A. The measurement apparatus 500A shown in FIG. 1 includes a LiDAR unit 100 and an optical head 200. The LiDAR unit 100 includes a light source 20, an interference optical system 30, a photodetector 50, a processing circuit 60, and a memory 62. The interference optical system 30 includes a splitter 32, a dividing element 34, and a coupling element 36. The optical head 200 includes an optical element 40 such as a collimator lens. A thick line shown in FIG. 1 represents an optical waveguide, such as an optical fiber, that connects two constituent elements to each other. An optical waveguide is herein sometimes referred to simply as “waveguide”. An arrowed solid line shown in FIG. 1 represents the flow of a signal. A dashed line shown in FIG. 1 represents light shone on a physical object 10.

The light source 20 can be, for example, a laser light source that emits laser light. The laser light that is emitted from the light source 20 is hereinafter sometimes referred to as “output light”. The light source 20 is capable of varying the frequency of the output light. The frequency of the output light can be modulated with constant periodicity, for example, in the form of a triangular wave or a sawtooth wave. The periodicity of the frequency does not need to be always constant but may change with passage of time. The periodicity of the frequency can be, for example, longer than or equal to 1 microsecond (μs) and shorter than or equal to 10 milliseconds (ms). A range of fluctuation in the frequency, i.e. a difference between a minimum value and a maximum value of the frequency, can be, for example, from 100 MHz to 1 THz. The wavelength of the output light can be included in a wavelength range of near-infrared light, for example, of 700 nm to 2000 nm. Using near-infrared light as the output light makes it possible to, even in the case of a measurement performed outdoors during the daytime, reduce the influence of noise attributed to sunlight. The wavelength of the output light does not necessarily need to be included in the wavelength range of near-infrared light. The wavelength of the output light may be included in a wavelength range of visible light of 400 nm to 700 nm or may be included in a wavelength range of ultraviolet light. The light source 20 can include, for example, a distributed feedback laser diode or a laser diode with an external resonator. These laser diodes are low in price and small in size, are capable of single-mode oscillation, and can vary the frequency of the output light according to the amount of current that is applied. The intensity and frequency of the output light that is outputted from the light source 20 can be controlled by a controller such as the processing circuit 60.

The splitter 32 is connected to the light source 20 via a waveguide 70, connected to the dividing element 34 via a waveguide 71, and connected to the coupling element 36 via a waveguide 75. The splitter 32 separates the output light emitted from the light source 20 into reference light and irradiating light that is shone on the physical object 10. The splitter 32 inputs the reference light to the coupling element 36 and inputs the irradiating light to the dividing element 34.

The dividing element 34 can be, for example, an optical splitter or a circulator. The dividing element 34 is connected to the splitter 32 via the waveguide 71, connected to the coupling element 36 via a waveguide 74, and connected to the optical element 40 of the optical head 200 via a waveguide 72. The dividing element 34 inputs the irradiating light from the splitter 32 to the optical element 40 and inputs reflected light from the physical object 10 to the coupling element 36.

The coupling element 36 can be, for example, an optical splitter or an optical coupler. The coupling element 36 inputs, to the photodetector 50, interfering light generated by interference between the reference light from the splitter 32 and the reflected light from the dividing element 34.

The optical element 40 emits outward the irradiating light having passed through the waveguide 72 and introduces the reflected light from the physical object 10 into the waveguide 72. The optical element 40 can be, for example, a collimator lens that collimates the irradiating light. The term “collimate” herein means not only a case where the irradiating light is turned into parallel light but also a case where the spread of the irradiating light is reduced. The optical element 40 is not limited to the collimator lens but may be a diffraction grating that emits the irradiating light outward as zero-order diffracted light and/or +N-order diffracted light (where N is an integer greater than or equal to 1). Measuring the distance to the physical object 10 with a plurality of rays of diffracted light emitted in different directions makes it possible to expand an angular range of measurement of the distance to the physical object 10.

The optical head 200 may include a beam scanner constituted, for example, by a MEMS (microelectromechanical system) or other components. The beam scanner makes it possible to change the direction of the irradiating light.

The photodetector 50 detects the interfering light outputted from the coupling element 36. The photodetector 50 includes one or more photodetection elements. The photodetection elements output electrical signals corresponding to the intensity of the interfering light.

In the measurement apparatus 500A, an optical path of the irradiating light from the interference optical system 30 to the physical object 10 and an optical path of the reflected light from the physical object 10 to the interference optical system 30 overlap each other. Employing such a coaxial optical system makes it possible to make the measurement apparatus 500A simple in configuration and achieve a stable measurement.

The processing circuit 60 functions as a controller that controls how the light source 20 and the photodetector 50 operate. The processing circuit 60 performs a process based on the FMCW-LiDAR technology. Specifically, the processing circuit 60 causes the light source 20 to emit light whose frequency varies with time, and causes the photodetector 50 to detect the interfering light generated by interference between the reference light and the reflected light from the physical object 10. The processing circuit 60 computes the distance to the physical object 10 and/or the velocity of the physical object 10 on the basis of a time-series signal outputted from the photodetector 50 and generates and outputs measurement data pertaining to the distance and/or the velocity.

The processing circuit 60 computes the distance and/or the velocity by executing a computer program stored in the memory 62 such as a ROM or a RAM (random-access memory). Thus, the measurement apparatus 500A includes a processor including the processing circuit 60 and the memory 62. The processing circuit 60 and the memory 62 may be integrated on one circuit board, or may be provided on separate circuit boards. Functions of control and signal processing by the processing circuit 60 may be dispersed across a plurality of circuits. The processor may be placed in a place away from other constituent elements. In that case, the processor may control, via a cable or wireless communication network, how the light source 20 and the photodetector 50 operate and process, via the communication network, a signal outputted from the photodetector 50.

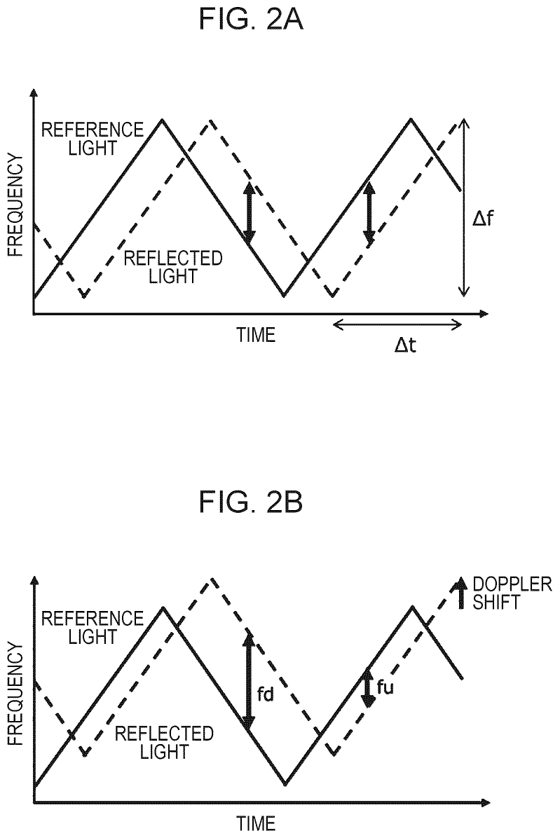

Next, a principle of distance and velocity measurement based on the FMCW-LiDAR technique is described with reference to FIGS. 2A and 2B.

FIG. 2A is a diagram schematically showing examples of time changes in the frequencies of reference light and reflected light in a case where the physical object 10 is at rest. The solid line represents the reference light, and the dashed line represents the reflected light. The frequency of the reference light shown in FIG. 2A repeats time changes in the form of a triangular wave. That is, the frequency of the reference light repeats per cycle an up chirp during which the frequency linearly increases and a down chirp during which the frequency then linearly decreases as much as it increased. The increase in the frequency in an up-chirp period and the decrease in the frequency in a down-chirp period are equal to each other. In a case where the total optical path length of the irradiating light and the reflected light is longer than the optical path length of the reference light, the frequency of the reflected light shifts in a positive direction along a time axis as compared with the frequency of the reference light. On the other hand, in a case where the total optical path length of the irradiating light and the reflected light is shorter than the optical path length of the reference light, the frequency of the reflected light shifts in a negative direction along the time axis as compared with the frequency of the reference light. The shift amount of time of the reflected light is proportional to the absolute value of the difference between the total optical path length of the irradiating light and the reflected light and the optical path length of the reference light. Accordingly, interfering light generated by interference between the reference light and the reflected light has a beat of a frequency corresponding to the absolute value of the difference between the frequency of the reflected light and the frequency of the reference light. The thick double-headed arrows shown in FIG. 2A represent the difference in frequency between the reference light and the reflected light. The photodetector 50 outputs a time-series signal indicating a change in intensity of the interfering light. Such a signal is called a beat signal. The frequency of the beat signal, i.e. a beat frequency, is equal to the absolute value of the difference in frequency between the reflected light and the reference light. The processing circuit 60 can compute the distance to the physical object 10 on the basis of the beat frequency.

In a case where the physical object 10 is at rest, a beat frequency in an up-chirp period and a beat frequency in a down-chirp period are equal to each other. Let it be assumed here that as indicated by a thin double-headed arrow in FIG. 2A, Δf is the range of fluctuations in the frequency of light during each of the up-chirp and down-chirp periods and Δt is the time required for the frequency to change by Δf. Let it also be assumed that c is the speed of light and that Δd is the absolute value of the difference between the total of the optical path lengths of the irradiating light and the reflected light and the optical path length of the reference light. The beat frequency f_{beat} in the up-chirp period or the down-chirp period is represented by Formula (1) as follows:

$${f}_{b e a t} = \frac{Δ f}{c Δ t} Δ d \qquad ( 1 )$$

The beat frequency f_{beat} is obtained by multiplying the time rate of change Δf/Δt in the frequency by the time (Δd/c) required for light to propagate by the optical path length difference Δd. Let it be assumed that as shown in FIG. 1, d₁ is the optical path length of the waveguide 71, d₂ is the optical path length of the waveguide 72, d₃ is an optical path length from the optical element 40 to the physical object 10, and d₄ is the optical path length of the waveguide 74. The optical path length difference Δd between the reflected light reflected back off the physical object 10 and the reference light is expressed by Formula (2) as follows:

$$Δ d = \vert {d}_{1} + 2 {d}_{2} + 2 {d}_{3} + {d}_{4} - {d}_{5} \vert \qquad ( 2 )$$

The optical path lengths d₁, d₂, d₄, and d₅ are predetermined fixed values. Further, Δf, Δt, and c in Formula (1) are also known values, and f_{beat} is obtained by a frequency analysis of the beat signal. Accordingly, the processing circuit 60 can calculate the distance d₃ from the optical element 40 to the physical object 10 on the basis of Formulas (1) and (2).

FIG. 2B is a diagram schematically showing examples of time changes in the frequencies of the reference light and the reflected light in a case where the physical object 10 is moving. As shown in FIG. 2B, in a case where the physical object 10 moves nearer to the optical head 200, a Doppler shift causes the frequency of the reflected light to shift in a positive direction along a frequency axis as compared with a case where the physical object 10 is at rest. On the other hand, in a case where the physical object 10 moves away from the optical head 200, a Doppler shift causes the frequency of the reflected light to shift in a negative direction along the frequency axis as compared with a case where the physical object 10 is at rest. The shift amount of frequency of the reflected light depends on the magnitude of a component obtained by projecting the velocity vector of an irradiated portion of the physical object 10 in the direction of the reflected light. In a case where the physical object 10 moves, the beat frequency can vary between an up-chirp period and a down-chirp period. In the example shown in FIG. 2B, a beat frequency fd in a down-chirp period during which the frequencies of both the reflected light and the reference light linearly decrease is higher than a beat frequency fu in an up-chirp period during which the frequencies of both the reflected light and the reference light linearly increase. The processing circuit 60 can calculate the velocity of the physical object 10 on the basis of this difference in beat frequency (fd-fu). The processing circuit 60 may calculate the distance from the optical head 200 to the physical object 10 with the average of the beat frequency fu in an up-chirp period and the beat frequency fd in a down-chirp period being the beat frequency f_{beat} in Formula (1) above.

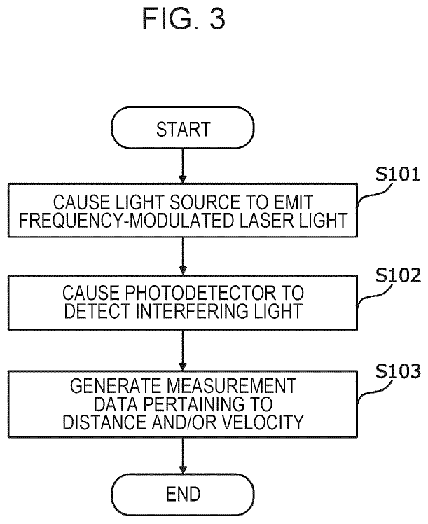

FIG. 3 is a flow chart schematically showing an example of a measuring operation that the processing circuit 60 executes. The processing circuit 60 executes the actions of steps S101 to S103 shown in FIG. 3.

In step S101, the processing circuit 60 causes the light source 20 to emit laser light whose frequency varies with time. In the examples shown in FIGS. 2A and 2B, the processing circuit 60 causes the light source 20 to emit laser light whose frequency varies in the form of a triangular wave. In the case of a use where the velocity of the physical object 10 is not measured and the distance to the physical object 10 is measured, the frequency of the laser light may be varied in the form of a sawtooth wave.

In step S102, the processing circuit 60 causes the photodetector 50 to detect interfering light generated by interference between reflected light and reference light. The photodetector 50 outputs, at predetermined intervals, a signal corresponding to the intensity of the interfering light.

In step S103, the processing circuit 60 computes the distance to and/or the velocity of the physical object 10 on the basis of the signal outputted from the photodetector 50. The processing circuit 60 may perform a process such as the fast Fourier transform (FFT) on the basis of a time-series signal outputted from the photodetector 50, obtain the intensity for each frequency component, and process, as the beat frequency, a frequency at which the intensity exceeds a threshold. The processing circuit 60 can generate data pertaining to the distance to and/or the velocity of the physical object 10 by performing the aforementioned computation on the basis of the beat frequency.

In the measurement apparatus 500A shown in FIG. 1, the LiDAR unit 100 and the optical head 200 are not accommodated in one housing but are separated from each other. The waveguide 72, which connects the LiDAR unit 100 and the optical head 200 to each other, can be achieved by, for example, a comparatively long optical fiber cable. Such a configuration makes it possible to reduce the volume and weight of the optical head 200 and increase the degree of freedom of placement of the optical head 200. Even in a case where the physical object 10 has a complex shape or a large size, the position and orientation of the optical head 200 can be flexibly changed according to the shape or the size.

In general, the wavelength stability of the light source 20 is susceptible to temperature, and changes in temperature affect the accuracy of measurement of the distance and the velocity. Further, the processing circuit 60, which is a precision device, requires vibration resistance in addition to temperature resistance. For this reason, the LiDAR unit 100 can include a housing having temperature resistance and vibration resistance. In the housing, the light source 20, the interference optical system 30, the photodetector 50, the processing circuit 60, and the memory 62 can be accommodated. This makes it possible to stabilize the accuracy of measurement of the distance and the velocity. The housing may contain only some of the light source 20, the interference optical system 30, the photodetector 50, and the processing circuit 60. For example, the housing may contain the light source 20, the interference optical system 30, and the photodetector 50 and may not contain the processing circuit 60 and the memory 62. Further, some or all of the light source 20, the interference optical system 30, the photodetector 50, the processing circuit 60, the memory 62, and waveguides and wires connecting them may be integrated on one chip. Such a configuration makes it possible to improve the degree of freedom of fabrication and design of the LiDAR unit 100.

In the configuration shown in FIG. 1, a beat signal that is outputted from the photodetector 50 can contain, in addition to a frequency component attributed to reflected light from the physical object 10, a frequency component (i.e. noise) attributed to light other than the reflected light from the physical object 10. Noise can be generated because a portion of the irradiating light inputted from the splitter 32 to the dividing element 34 travels toward the coupling element 36 instead of traveling toward the optical element 40 and falls on the photodetector 50. Further, noise can be generated because a portion of the irradiating light having passed through the waveguide 72 is reflected off a lens surface instead of passing through the optical element 40. Furthermore, noise can be generated due to reflections of light that occur inside the waveguide 72, which connects the dividing element 34 and the optical element 40 to each other. In particular, as in the example shown in FIG. 1, in a case where the dividing element 34 and the optical element 40 are connected to each other by the waveguide 72 such as a comparatively long optical fiber cable, the optical path of the irradiating light varies according to the position of the optical head 200, so that reflections of light and crosstalk tend to occur in the optical path. This can result in generation of noise in a beat signal that is detected by the photodetector 50, creation of a distance range within which the distance or the velocity cannot be measured, and a narrowing of a measurable distance range.

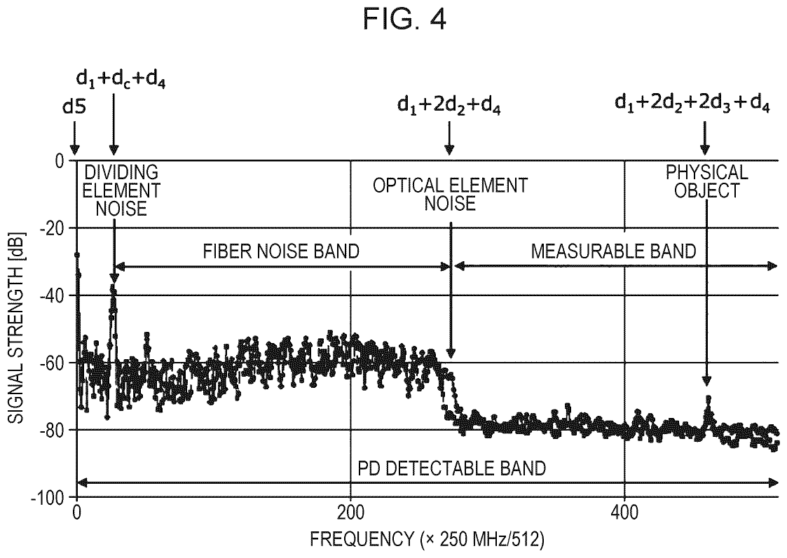

According to the inventors' study, the expansion of a measurable distance range can be achieved by reducing the influence of noise by appropriately adjusting the optical path lengths d₁, d₂, d₄, and d₅ shown in FIG. 1. A relationship between the optical path lengths d₁, d₂, d₄, and d₅ and the influence of noise is explained in more detail with reference to FIG. 4.

FIG. 4 is a graph showing an example of the strength of a beat signal for each frequency component, i.e. the power spectra of the beat signal. By performing a process such as the FFT on the basis of a beat signal outputted from the photodetector 50, the processing circuit 60 can generate data on power spectra such as those shown in FIG. 4. In the graph shown in FIG. 4, the horizontal axis represents frequency, and the vertical axis represents signal strength. In the example shown in FIG. 4, the frequency is expressed by numerical values of 9 bits (from 0 to 511), and the width of each gradation represents 250 MHz/512. The frequency on the horizontal axis corresponds to the absolute value of the difference between an optical path length from the splitter 32 to the coupling element 36 and the optical path length d₅ of the reference light. When the optical path length is equal to the optical path length d₅ of the reference light, the frequency becomes zero. In FIG. 4, a spectrum in an up-chirp period and a spectrum in a down-chirp period are superimposed on each other. In a case where the physical object 10 is at rest, these spectra behave substantially in the same way.

In this example, the frequency of laser light from the light source 20 is modulated in the form of a triangular wave as shown in FIG. 2A. In a case where the physical object 10 is at rest, peaks of the beat signal appear at frequencies corresponding to the optical path length in both the up-chirp and down-chirp periods of the triangular wave. In a case where the physical object 10 has a velocity, there is a difference between frequencies of the beat signal between the up-chirp period and the down-chirp period, so that the velocity can be detected on the basis of the frequency difference.

In the configuration shown in FIG. 1, when noise light from an object other than the physical object 10 enters the photodetector 50, noise is generated in the beat signal on the basis of the aforementioned Formula (1). FIG. 4 shows optical element noise generated in the optical element 40 and dividing element noise generated in the dividing element 34.

The optical element noise can be generated by reflections at an interface between an optical fiber constituting the waveguide 72 and air and an interface between air and glass of the optical element 40 (e.g. a collimator lens). The optical element noise is generated at a frequency corresponding to the absolute value |d₁+2d₂+d₄−d₅| of the difference between the optical path length d₁+2d₂+d₄ of light exiting the splitter 32, reflected off the optical element 40, and arriving at the coupling element 36 and the optical path length d₅ of the reference light from the splitter 32 to the coupling element 36. In the example shown in FIG. 4, the optical path length d₁+2d₂+d₄ is longer than the optical path length d₅ of the reference light. In this case, the optical path length d₁+2d₂₊₂d₃+d₄ of light exiting the splitter 32, reflected off the physical object 10, and arriving at the coupling element 36 is greater than the optical path length d₅ of the reference light, so that the corresponding frequency becomes higher. Therefore, assuming that the frequency at which the optical element noise is generated corresponds to zero distance, a frequency that is higher than the frequency can be treated as a frequency to be measured. Accordingly, the optical element noise has only a small effect on the measurement of the distance to the physical object 10.

The dividing element noise is generated when a portion of light inputted from the splitter 32 to the dividing element 34 (e.g. a circulator) travels not toward the optical element 40, toward which the light is originally supposed to travel, but toward the coupling element 36 and enters the photodetector 50. It is experimentally confirmed that the optical path length in the dividing element 34 of noise light that generates the dividing element noise is longer than the total of the optical path lengths in the dividing element 34 of irradiating light traveling from the dividing element 34 toward the optical element 40 and reflected light generated due to reflection of the irradiating light. This difference in optical path length is hereinafter expressed as the optical path length d_{c} of the noise light in the dividing element 34. In the example shown in FIG. 4, the absolute value |d₁+d_{c}+d₄-d₅| of the difference between the optical path length d₁+d+d₄ of the noise light from the splitter 32 to the coupling element 36 and the optical path length d₅ of the reference light is small, so that the effect on the measurement of the distance to the physical object 10 is small. However, in a case where d₅ is great, the optical path length difference |d₁+d₂+d₄ d₅| corresponding to the dividing element noise can become greater than the optical path length difference |d₁+2d₂+d₄−d₅| corresponding to the optical element noise. In that case, the dividing element noise can be generated near the beat frequency of the physical object 10, so that it becomes impossible to distinguish between the beat frequency of the physical object 10 and the noise. As a result, it becomes impossible to measure the distance and the velocity in a band in which the dividing element noise is generated. As in the example shown in FIG. 4, the effect of the dividing element noise on the measurement can be reduced by causing the dividing element noise to be generated at a frequency that is lower than the frequency at which the optical element noise is generated.

In the example shown in FIG. 4, the noise floor is higher on the low-frequency side by approximately 20 dB than it is on the high-frequency side of a frequency of approximately 280 (×250 MHz/512) on the horizontal axis. Depending on the values of the optical path lengths d₁, d₂, d₄, and d₅, this high noise floor can also be generated in a band of frequencies for measuring the distance to or the velocity of the physical object 10. In a case where the physical object 10 has a low reflectance, a band of frequencies in which measurement becomes impossible due to the influence of the noise floor can be generated. For this reason, a band of frequencies in which measurement is possible even in the case of a low reflectance (such a band of frequencies being referred to as “measurable band”) can become narrower. In the example shown in FIG. 4, a band of frequencies that are able to be detected by the photodetector 50 (such a band of frequencies being referred to as “PD detectable band”) is 250 MHz, 50% or more of which is occupied by noise.

Depending on the values of the optical path lengths d₁, d₂, d₄, and d₅, the measurable band can become even narrower.

The inventors analyzed a factor in this rise in noise floor and found that the optical path length d₂ of the waveguide 72 shown in FIG. 1 was responsible for the rise. The optical fiber constituting the waveguide 72 causes Rayleigh scattering due to particles in the optical fiber that are sufficiently smaller than wavelengths or fluctuations in density, stress, or composition. For this reason, back scattering of light throughout the optical fiber can occur. Noise light generated by back scattering inside the waveguide 72 passes through the same path as the reflected light from the physical object 10 and enters the photodetector 50. This is the cause of a noise band. This noise band, which is attributed to the optical fiber, is referred to as “fiber noise band”. Also in a case where the waveguide 72 is an optical waveguide other than an optical fiber cable, similar noise can be generated due to a similar factor.

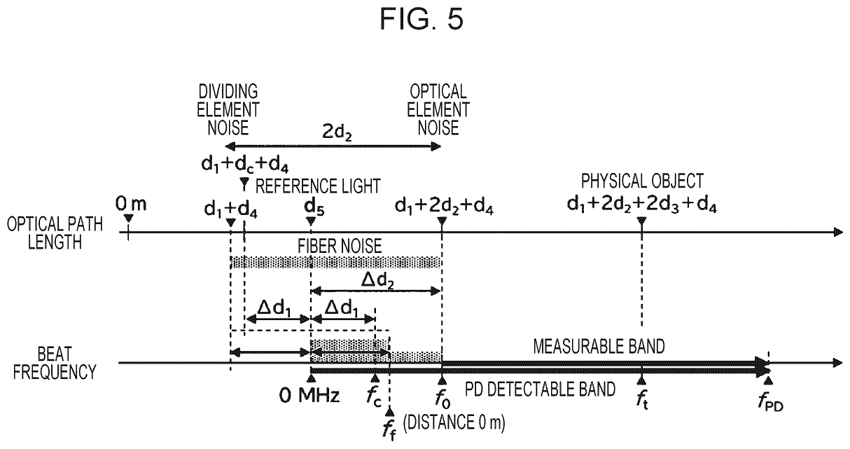

The width of the fiber noise band depends on the optical path length d₂ of the waveguide 72. To expand the measurable band by narrowing the fiber noise band, it is effective to shorten the optical path length d₂ of the waveguide 72. However, shortening the optical path length d₂ makes it difficult to separately place the optical head 200 and the LiDAR unit 100. FIG. 5 is a diagram for explaining a relationship between optical path length and beat frequency and the influence of various types of noise in more detail. The optical path length here represents an optical path length starting at the splitter 32 and ending at the coupling element 36.

In the example shown in FIG. 5, the optical path length d₅ of the reference light is longer than the optical path length d₁+d_{c}+d₄ of the light that generates the dividing element noise and shorter than the optical path length d₁+2d₂+d₄ of light that generates the optical element noise. The dividing element noise is generated at a frequency f_{c} corresponding to the absolute value Δd₁ of the difference between d₁+d_{c}+d₄ and d₅. The optical element noise is generated at a frequency f₀ corresponding to the absolute value Δd₂ of the difference between d₁+2d₂+d₄ and d₅. The frequency f_{c} corresponds to a zero-meter point of measurement of the distance. Assuming that f₀ is the maximum value of a frequency that is able to be detected by the photodetector 50, the measurable band ranges from f₀ to f_{pD}. Let it be assumed that fₜ is a beat frequency corresponding to the reflected light from the physical object 10.

The fiber noise is generated in a band of frequencies of 0 to f₀. This band is a fiber noise band. At a frequency fᵣ corresponding to a range of 0 to |d₁+d₄−d₅| in the fiber noise band, the fiber noise is doubly generated, so that the intensity of noise is approximately twice as high.

In the example shown in FIG. 5, d₅ is smaller than the average of d₁+d_{c}+d₄ and d₁+2d₂+d₄. For this reason, f_{c} is smaller than f₀. In this case, the dividing element noise does not affect the measurement of the distance. In a case where d₅ is greater than the average of d₁+d_{c}+d₄ and d₁+2d₂+d₄ unlike in this example, f_{c} exceeds f₀, so that short-distance measurement, in particular, is affected. Setting the optical path lengths d₁, d₂, d₄, and d₅ so that Δd₁<Δd₂, i.e. |d₁+d_{c}+d₄-d₅|<|d₁+2d₂+d₄-d₅|, is satisfied makes it possible to reduce the effect of the dividing element noise on the measurement of the distance. In a case where d_{c} is sufficiently smaller than d₁ and d₄, the optical path lengths d₁, d₂, d₄, and d₅ may be set with an approximation d_{c}=0 so that |d₁+d₄-d₅|<|d₁+2d₂+d₄−d₅| is satisfied.

The band of frequencies that are able to be detected with the photodetector 50, i.e. the PD detectable range, is the range of 0 to f_{PD}. Of the range, the range of f₀ to f_{PD} is a measurable band in which the distance to or the velocity of the physical object 10 can be measured. Lowering the frequency f_{c} makes it possible to expand the measurable band. The frequency f₀ can be lowered by adjusting the optical path lengths d₁, d₂, d₄, and d₅. For example, the frequency f₀ can be lowered by bringing the optical path length d₅ of the reference light close to d₁+2d₂+d₄. However, simply bringing d₅ close to d₁+2d₂+d₄ causes the effect of the dividing element noise or the fiber noise to reach a frequency exceeding the frequency f₀ and can result, on the contrary, in a narrower measurable band.

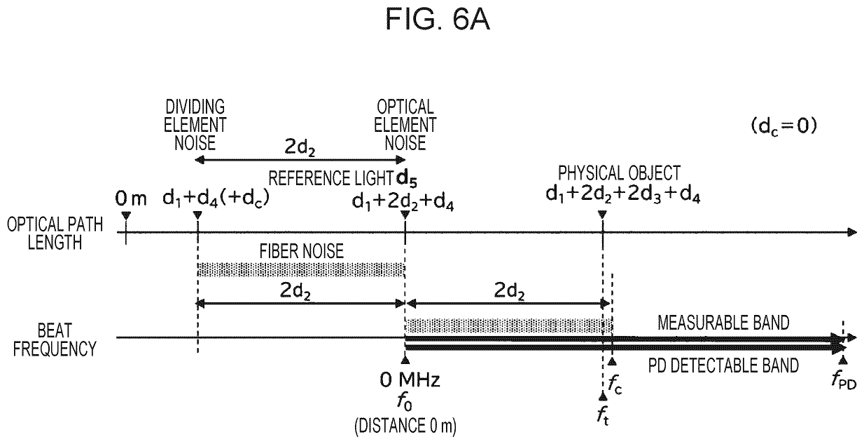

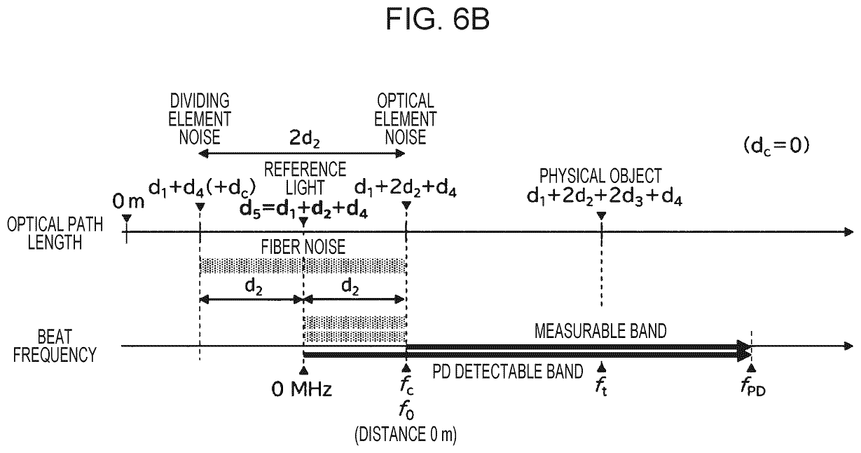

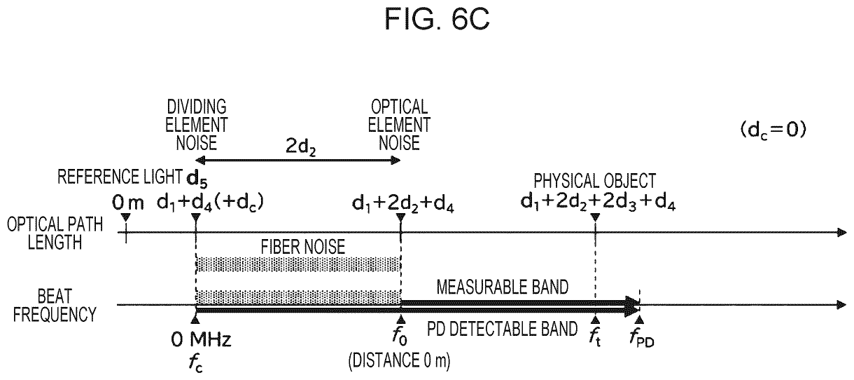

FIGS. 6A to 6C are diagrams showing examples of various frequencies with changes in the optical path length d₅ of the reference light. Let it be assumed for simplicity here that d_{c}=0. FIG. 6A shows an example of a case where d₅=d₁+2d₂+d₄. FIG. 6B shows an example of a case where d₅=d₁+d₂+d₄. FIG. 6C shows an example of a case where d₅=d₁+d₄.

As shown in FIG. 6A, in a case where the optical path length d₅ of the reference light matches the optical path length d₁+2d₂+d₄ of reflected light reflected off the optical element 40, the frequency f₀ corresponding to the optical element noise reaches its minimum of 0 MHz, and this frequency corresponds to a distance of 0 m. For this reason, it seems that a range of distances in which distance measurement is possible (hereinafter also called “distance-measuring range”) can be widened most. However, in this case, the fiber noise and the dividing element noise are generated at the frequency f_{c} corresponding to the optical path length difference 2d₂, so that a physical object whose signal is weak cannot be detected in a band of frequencies of 0 to f_{c}. Accordingly, the actual distance-measuring range is narrowed down to a range of distances corresponding to a range of frequencies f_{c} to f_{PD}.

As shown in FIG. 6B, it is in a case where the optical path length d₅ of the reference light is made equal to d₁+d₂+d₄ that a maximum distance-measuring range is attained with the fiber noise taken into account. In this case, the fiber noise band is a band of frequencies of 0 to f_{c} corresponding to the optical path length d₂. In this example, the frequency f_{c} corresponding to the dividing element noise and the frequency f₀ corresponding to the optical element noise match each other, and neither fiber noise nor dividing element noise appears in a band of frequencies that are higher than the frequency. Since the fiber noise band can be reduced by a half as compared with the example shown in FIG. 6A, the measurable band, i.e. the distance-measuring range, can be expanded.

Meanwhile, as shown in FIG. 6C, in a case where the optical path length d₅ of the reference light is made equal to an optical path length d₁+d₄ corresponding to the dividing element noise, the fiber noise band is a band of frequencies of 0 to f₀ corresponding to the optical path length difference 2d₂ from 0 MHz. In this case, the optical element noise does not appear, but the fiber noise appears in the widest band as in the case of FIG. 6A. This results in a narrower distance-measuring range. In a case where the optical path length d₅ of the reference light is made shorter than d₁+d₄, the frequency f₀ corresponding to the optical element noise becomes even higher, and a band that does not contribute to measurement appears in a band that is lower than the fiber noise band, so that the measurable band becomes even narrower. Therefore, the optical path length d₅ of the reference light is set to a value that is higher than or equal to d₁+d₄.

As shown in FIG. 6C, the measurement apparatus 500A can be designed to be able to measure the distance to and/or the velocity of the physical object 10 even in a case where the optical path length d₅ of the reference light matches d₁+d₄ and the fiber noise band appears in the widest band equivalent to the optical path length difference 2d₂. In the example shown in FIG. 6C, the upper-limit frequency f₀ of the fiber noise band is expressed by Formula (3) as follows:

$${f}_{0} = 2 {d}_{2} \times Δ f / c Δ t \qquad ( 3 )$$

In order to make it possible to measure the distance to the physical object 10, the measurement apparatus 500A can be designed so that the fiber noise band falls within the PD detectable band. That is, the measurement apparatus 500A can be designed to satisfy Formula (4) as follows:

$${f}_{P D} > 2 {d}_{2} \times Δ f / c Δ t \qquad ( 4 )$$

In a case where the maximum value of a frequency that is able to be detected by a frequency analysis by the processing circuit 60 is lower than the maximum value of the frequency that is able to be detected by the photodetector 50, Formula (4) may be satisfied with the latter frequency being f_{pD}.

Further, when Dₜ is the measurable maximum value of the distance from the optical element 40 to the physical object 10, the measurement apparatus 500A can be designed so that a target frequency corresponding to Dₜ falls within the PD detectable band. The target frequency is the sum of the frequency f₀, which depends on d₂, and the frequency shift amount, which depends on Dr. That is, the measurement apparatus 500A can be designed to satisfy Formula (5) as follows:

$${f}_{P D} > ( 2 {d}_{2} + 2 {D}_{t} ) \times Δ f / c Δ t \qquad ( 5 )$$

It is desirable that the fiber noise band be less than 50% of the PD detectable band, that is, the distance-measuring range be 50% or more. Accordingly, the measurement apparatus 500A can be designed to satisfy Formula (6) as follows:

$$\frac{2 {d}_{2} \times Δ f / c Δ t}{{f}_{P D}} < 0.5 \qquad ( 6 )$$

As one example, in a case where Δf=9.2 GHz, Δt=10 microseconds (μs), f_{pD}=250 MHz, and the distance to a physical object at a distance of 20 meters (m) ahead is measured, a target frequency corresponding to the distance to the physical object is approximately 170 MHz, which is a frequency of 68% of 250 MHz. If Formula (6) above is satisfied, it is possible to measure the distance to such a physical object.

As can be seen from Formula (3), the fiber noise band can be reduced by decreasing Δf. Meanwhile, the resolution of distance measurement depends on Δf. For example, in a case where Δf is 9.2 GHz, the distance to a physical object at a distance of 1 meter (m) ahead can be measured with millimeter (mm) accuracy.

Since the fiber noise band depends on the optical path length d₂ of the waveguide 72 as noted above, bringing d₂ close to 0 makes it possible to reduce the effect of the fiber noise. However, bringing d₂ close to 0 can cause the optical element noise to have an effect.

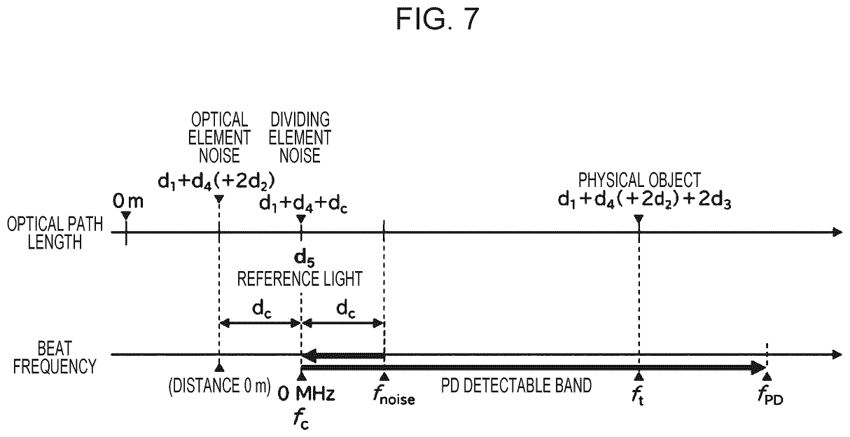

FIG. 7 is a diagram for explaining the influence of optical element noise in a case where the optical path length d₂ of the waveguide 72 is brought close to 0. In this example, the optical path length d_{c} of noise light inside the dividing element 34 is taken into account. The optical element noise is generated at a frequency corresponding to the absolute value of the difference between the optical path lengths d₁+d₄₊₂d₂ and d₅. In a case where d_{2 =0}, the optical element noise is generated at a frequency corresponding to the absolute value of the difference between the optical path lengths d₁+d₄ and d₅. Meanwhile, the dividing element noise is generated at a frequency corresponding to the absolute value of the difference between the optical path lengths d₁+d₄+d_{c} and d₅. In the example shown in FIG. 7, the optical path length d₅ of the reference light is equal to the optical path length d₁+d₄+d_{c} of the noise light that generates the dividing element noise. In this case, the optical element noise is generated at a frequency fnoise corresponding to the optical path length difference d_{c}. Further, since the point of distance 0 corresponds to the optical path length d₁+d₄ (+2d₂), which is shorter than the optical path length d₅ of the reference light, two different distances correspond to the same target frequency in a section of 2d_{c}. This makes it impossible to measure distance in this section. Such a problem can be avoided by designing the measurement apparatus 500A to satisfy Formula (7) as follows:

$$2 {d}_{2} \geq {d}_{c} \qquad ( 7 )$$

The dividing element 34 can be, for example, a circulator or a splitter. No matter whether the dividing element 34 is a circulator or a splitter, the various optical path lengths can be adjusted to satisfy Formula (7) in view of the optical path length d_{c} of noise light that directly propagates from the light source 20 toward the photodetector 50.

Furthermore, in a case where the optical path length d₅ of the reference light is different from d₁+d₄+de, the dividing element noise is generated. The distance-measuring range can be widened by adjusting the variety of optical path lengths so that spectroscopic element noise is generated at a lower frequency than is the dividing element noise. Therefore, the measurement apparatus 500A can be designed to satisfy Formulas (8) and (9) as follows:

$${d}_{5} \leq {d}_{1} + 2 {d}_{2} + {d}_{4} \qquad ( 8 )$$

$$\vert {d}_{1} + 2 {d}_{2} + {d}_{4} - {d}_{5} \vert \geq \vert {d}_{1} + {d}_{4} + {d}_{c} - {d}_{5} \vert \qquad ( 9 )$$

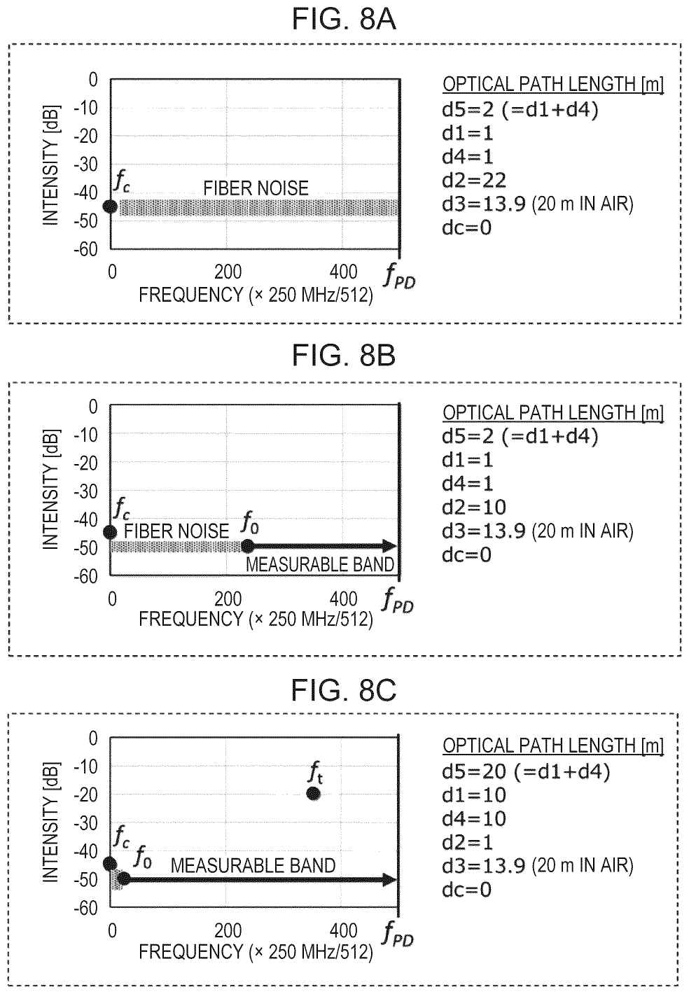

FIGS. 8A to 8C are diagrams showing examples of changes in the frequencies of various types of noise and the target frequency in a case where various optical path lengths are adjusted. In each of the examples, Δf=9.2 GHZ, Δt=10 microseconds (μs), and f_{PD}=250 MHz. The optical path lengths d₁, d₂, d₃, d₄, d₅, and d_{c} in each of the examples shown in FIGS. 8A to 8C are as shown on the right side of the graph.

In the example shown in FIG. 8A, the optical path length d₂ of the optical waveguide 72 is 22 m. In the example shown in FIG. 8B, the optical path length d₂ of the optical waveguide 72 is 10 m. In the example shown in FIG. 8C, the optical path length d₂ of the optical waveguide 72 is 1 m. In each of the examples, the optical path length d₅ of the waveguide 75 is equal to d₁+d₄. In the examples shown in FIGS. 8A and 8B, d₁=d₄₌₁ m, and d₅₌₂ m. In the example shown in FIG. 8C, d₁=d₄₌₁₀ m, and d₅=20 m. In each of the examples, the optical path length d_{c} is 0 m.

In the example shown in FIG. 8A in which d₂=22 m, Formula (4) above is not satisfied. For this reason, the fiber noise fills the entire PD detectable band, making it impossible to measure the distance and the velocity. To make a measurement, it is necessary to further shorten the optical path length d₂.

In the example shown in FIG. 8B in which d₂=10 m, Formulas (4), (6), (7), (8), and (9) are satisfied. In this case, the measurable band becomes 50% or more of the PD detectable band, so that it is possible to measure distance. However, since the frequency f₀ shown in Formula (3) is high and the measurable band is somewhat narrow, Formula (5) is not satisfied for a physical object at a distance of 20 m ahead, so that the distance cannot be measured.

On the other hand, in the example shown in FIG. 8C in which d₂=1 m, d₁=d₄₌₁₀ m, and d₅=20 m, the fiber noise band can be narrowed, as d₂ is short. This makes it possible to widen the measurable band. In this case, all of Formulas (4), (5), (6), (7), (8), and (9) are satisfied, so that it is possible to measure the distance to a physical object at a distance of 20 m ahead.

As shown in FIG. 5, according to the optical path length d₅ of the reference light, the fiber noise band can include a band in which the intensity of fiber noise is twice as high and a band in which the intensity of fiber noise is once as high. In a case where the strength of a beat signal attributed to reflected light from a physical object is more than once as high and lower than twice as high as the intensity of fiber noise, the distance-measuring range can be widened by also utilizing the band in which the intensity of fiber noise is once as high.

Although, in the example shown in FIG. 1, the LiDAR unit 100 and the optical head 200 are separated from each other, they do not need to be separated from each other. For example, each constituent element of the LiDAR unit 100 and the optical element 40 may be accommodated in one housing. Even in that case, the measurable distance range can be expanded by setting each optical path length so that some or all of Formulas (4), (5), (6), (7), (8), and (9) above are satisfied.

In a case where a plurality of optical heads 200 are provided, the dividing element 34 may be replaced by an optical router placed between the LiDAR unit 100 and each optical head 200 so that an optical head 200 that performs the input and output of light can be selected. In a case where the dividing element 34 is a splitter, light intensity becomes ½ time as high when light is divided or coupled. This may be avoided by placing an optical router instead of the splitter so that one optical head 200 can be selected from among the plurality of optical heads 200. This makes it possible to reduce optical losses at the time of dividing and coupling.

### Example of Measurement Apparatus Including Plurality of Optical Heads

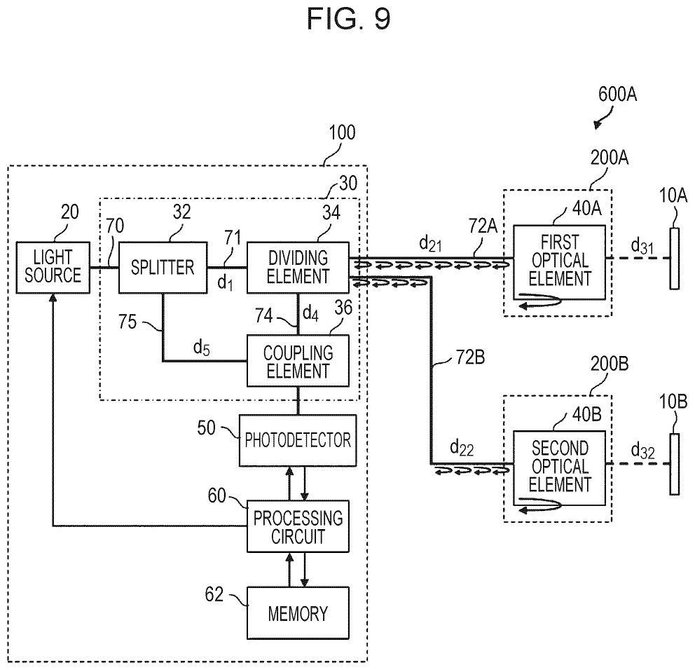

Although, in the example configuration shown in FIG. 1, only one optical head 200 is provided, a plurality of optical heads 200 may be provided. FIG. 9 is a block diagram showing a configuration of a measurement apparatus including a plurality of optical heads. The measurement apparatus 600A shown in FIG. 9 includes a LiDAR unit 100 and two optical heads 200A and 200B. The constituent elements of the LiDAR unit 100 are similar to those of the example shown in FIG. 1. In the example shown in FIG. 9, the dividing element 34 and the first optical head 200A are connected to each other by a waveguide 72A, and the dividing element 34 and the second optical head 200B are connected to each other by a waveguide 72B. Causing the optical path length d₂₁ of the waveguide 72A and the optical path length d₂₂ of the waveguide 72B to be different lengths makes it possible to measure the distances to or the velocities of a plurality of physical objects 10A and 10B or a plurality of portions of one physical object. Let it be assumed here that d₃₁ is the distance from a first optical element 40A included in the first optical head 200A to the physical object 10A and that d₃₂ is the distance from a second optical element 40B included in the second optical head 200B to the physical object 10B. In this case, the measurable distance range can be expanded by determining each optical path length so that some or all of the aforementioned Formulas (4), (5), (6), (7), (8), and (9) are satisfied with the optical path length d₂₁ or d₂₂ being d₁ and d₃₁ or d₃₂ being d₃. Alternatively, three or more optical head 200 may be provided.

The configuration shown in FIG. 9, the positions or angles of the first and second optical elements 40A and 40B, which function as beam shapers, can be adjusted according to the respective physical objects. There may be a single physical object or a plurality of physical objects. In a case where there is a single physical object, different portions of the single physical object may be irradiated by making the positions and/or angles of the optical elements 40A and 40B different from each other. This makes it possible to obtain more information about the scene to be measured. A portion of a single physical object or portions of a plurality of physical objects that are irradiated with light and distances to or velocities of which are measured are hereinafter referred to as “targets”. By varying the length of a waveguide (e.g. an optical fiber cable) from the dividing element 34 to each optical element, the position of each optical element can be adjusted according to the object to be measured. In particular, to measure the distances to or the velocities of a plurality of physical objects with one photodetector 50, it is effective to divide a band of frequencies that are able to be detected by the photodetector 50 into a band for the first optical head 200A and a band for the second optical head 200B.

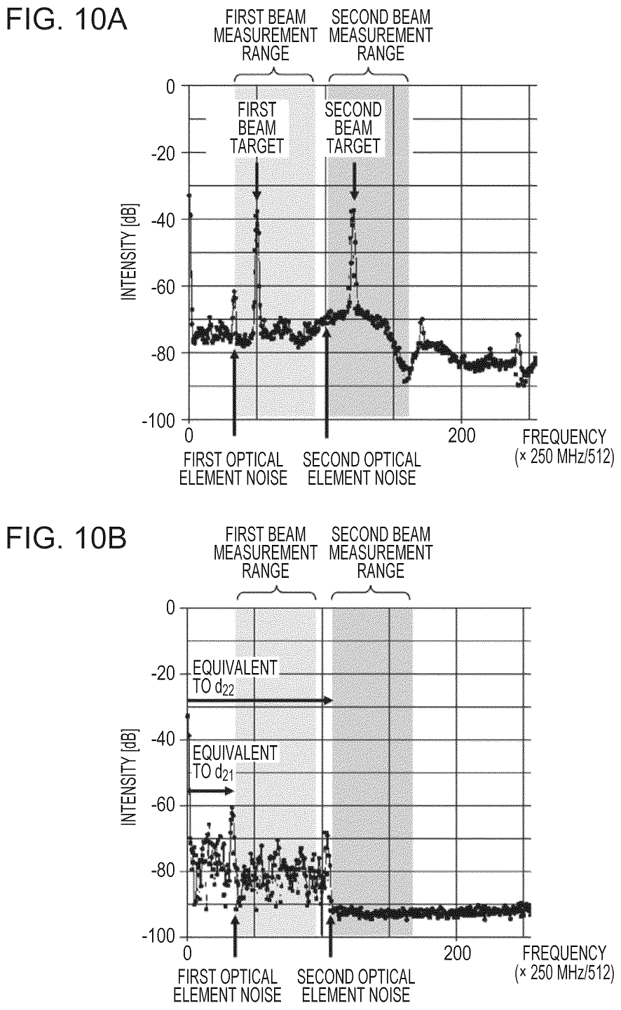

FIGS. 10A and 10B are diagrams showing examples of the power spectra of beat signals that are detected in the configuration shown in FIG. 9. The horizontal axis represents frequency, and the vertical axis represents signal strength. The frequency of a beat signal is proportional to the absolute value of the difference between the optical path length of the irradiating light and the optical path length of the reference light. When the optical path length of the irradiating light and the optical path length of the reference light match each other, the frequency at which a beat signal is generated becomes 0.

A light beam emitted from the first optical head 200A is herein referred to as “first beam”, and a light beam emitted from the second optical head 200B is herein referred to as “second beam”. A physical object or a portion that is irradiated with the first beam is referred to as “first beam target”, and a physical object or a portion that is irradiated with the second beam is referred to as “second beam target”. Noise caused by reflected light generated on a collimator lens surface of the first optical element 40A is referred to as “first optical element noise”, and noise caused by reflected light generated on a collimator lens surface of the second optical element 40B is referred to as “second optical element noise”.

FIG. 10A is a diagram showing an example of the power spectra of beat signals obtained when both the first beam and the second beam are shone on the respective targets. FIG. 10B is a diagram showing an example of the power spectra of beat signals obtained when both the first beam and the second beam are blocked. In this example, the optical path length d₂₁ from the dividing element 34 to the optical element 40A is 2.5 m, the optical path length d₂₂ from the dividing element 34 to the optical element 40B is 5.5 m, and the distance from each of the optical elements to the position of irradiation of the corresponding physical object is 1 m. The optical path lengths d₂₁ and d₂₂ are set so that a first beam measurement range and a second measurement range do not overlap each other. The first beam measurement range is a frequency range of a beat signal attributed to reflected light generated by irradiation with the first beam, and the second beam measurement range is a frequency range of a beat signal attributed to reflected light generated by irradiation with the second beam. The frequency at which the first optical element noise is generated corresponds to zero distance of measurement of the distance by the first beam, and the frequency at which the second optical element noise is generated corresponds to zero distance of measurement of the distance by the second beam. In the example shown in FIG. 10A, a peak frequency corresponding to the first beam target appears in the first beam measurement range, and a peak frequency corresponding to the second beam target appears in the second beam measurement range.

In this example, the round-trip optical path length of the second beam is longer by 6 m than the round-trip optical path length of the first beam. Due to the optical path length difference, the frequency at which the second optical element noise is generated is higher than the frequency at which the first optical element noise is generated. Adjusting the optical path length difference as appropriate makes it possible to, as shown in FIGS. 10A, divide from each other a range that can be measured with the first beam and a range that can be measured with the second beam.

As shown in FIG. 10B, the first beam measurement range is high in noise level by approximately 20 dB than the second beam measurement range. This noise increase may make it impossible to measure a low-reflectance target.

The inventors analyzed a factor in this noise and found that the optical path lengths d₂₁ and d₂₂ shown in FIG. 9 were responsible for the noise. As mentioned earlier, when noise light generated by back scattering that occurs in optical fibers in the waveguides 72A and 72B enters the photodetector 50, fiber noise is generated. The fiber noise depends on the lengths of the waveguides 72A and 72B. For example, as shown in FIG. 9, in a case where the waveguide 72B is longer than the waveguide 72A, a distance range within which a measurement cannot be made by the first beam can be created due to the influence of fiber noise attributed to back scattering having occurred in the waveguide 72B. This problem can similarly arise also in a case where the waveguides 72A and 72B are waveguides other than optical fibers. To expand the distance-measuring range by narrowing the band in which the fiber noise is generated, it is effective to make a design so that d₂₁ and d₂₂ are short.

However, to divide the frequency band of measurement between the first beam target and the second beam target, it is necessary to vary the optical path lengths between the first beam target and the second beam target. The optical path lengths varying between the first beam target and the second beam target are d₂₁ and d₂₂ or d₃₁ and d₃₂. Since d₃₁ and d₃₂ are distances from the respective optical elements to the respective targets and depend on the targets, it is difficult to adjust d₃₁ and d₃₂. Further, making the optical path lengths d₂₁ and d₂₂ of the waveguides 72A and 72B different from each other causes the fiber noise attributed to the longer optical path length to overlap the beat frequency of the shorter target as shown in FIG. 10B, making it impossible to measure the distance to a low-reflectance object with a beam of the shorter optical path length. Further, depending on the optical path length d₂₁ of the waveguide 72A, the distance cannot be measured in a frequency band from 0 MHz to the frequency at which the first optical element noise is generated. Since the PD detectable band, which is a band of frequencies that are able to be detected by the photodetector 50 and the processing circuit 60, is fixed, a widening of the fiber noise band by increases in the optical path lengths d₂₁ and d₂₂ causes a narrowing of the distance-measuring range.

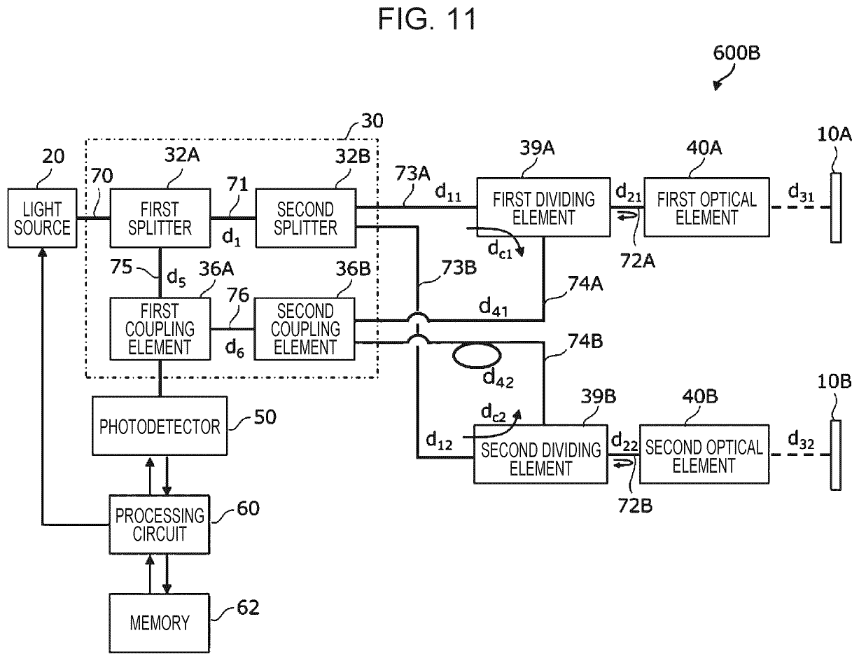

FIG. 11 is a block diagram schematically showing a configuration of a measurement apparatus 600B having an optical system to solve the foregoing problem. In the measurement apparatus 600B, the interference optical system 30 includes a first splitter 32A, a second splitter 32B, a first coupling element 36A, and a second coupling element 36B. The measurement apparatus 600B includes a first dividing element 39A connected between the second splitter 32B and a first optical element 40A and a second dividing element 39B connected between the second splitter 32B and a second optical element 40B. Each of the first and second dividing elements 39A and 39B can be, for example, a circulator or a splitter. Using a circulator makes it possible to reduce a propagation loss. Each of the first and second coupling elements 36A and 36B can be, for example, a coupler or a splitter. The constituent elements shown in FIG. 11 that exclude physical objects 10A and 10B may be accommodated in one housing or, as in the case of the example shown in FIG. 9, may be separately accommodated in a housing of a LiDAR unit and housings of a plurality of optical heads. For example, the first dividing element 39A and the first optical element 40A can be accommodated in one optical head, and the second dividing element 39B and the second optical element 40B can be accommodated in another optical head.

In FIG. 11, a plurality of optical waveguides are indicated by thick lines. Those optical waveguides include waveguides 70, 71, 72A, 72B, 73A, 73B, 74A, 74B, 75, and 76. Of these, the waveguide 72A is sometimes referred to as “first waveguide”, the waveguide 72B as “second waveguide”, the waveguide 74A as “third waveguide”, the waveguide 74B as “fourth waveguide”, the waveguide 73A as “fifth waveguide”, and the waveguide 73B as “sixth waveguide”. Each waveguide can be, for example, an optical fiber cable or an optical waveguide that is on an IC chip.

The first splitter 32A divides light inputted from the light source 20 via the waveguide 70 into irradiating light with which one or more physical objects that are present in a scene are irradiated and reference light. The irradiating light is sent to the second splitter 32B via the waveguide 71. The reference light is sent to the first coupling element 36A via the waveguide 75.

The second splitter 32B divides the irradiating light from the first splitter 32A into first irradiating light and second irradiating light. The first irradiating light is sent to the first dividing element 39A via the fifth waveguide 73A. The second irradiating light is sent to the second dividing element 39B via the sixth waveguide 73B.

The first dividing element 39A outputs, to the first waveguide 72A, the first irradiating light inputted from the fifth waveguide 73A and outputs, to the third waveguide 74A, first reflected light inputted from the first waveguide 72A.

The first optical element 40A shapes the first irradiating light sent from the first dividing element 39A via the first waveguide 72A and emits the first irradiating light toward the first physical object 10A. The first optical element 40A also introduces the first reflected light from the first physical object 10A into the first waveguide 72A and sends the first reflected light to the first dividing element 39A.

The second dividing element 39B outputs, to the second waveguide 72B, the second irradiating light inputted from the sixth waveguide 73B and outputs, to the fourth waveguide 74B, second reflected light inputted from the second waveguide 72B.

The second optical element 40B shapes the second irradiating light sent from the second dividing element 39B via the second waveguide 72B and emits the second irradiating light toward the second physical object 10B. The second optical element 40B also introduces the second reflected light from the second physical object 10B into the second waveguide 72B and sends the second reflected light to the second dividing element 39B.

The second coupling element 36B is connected to the first coupling element 36A via the waveguide 76, connected to the first dividing element 39A via the waveguide 74A, and connected to the second dividing element 39B via the waveguide 74B. The second coupling element 36B inputs, to the first coupling element 36A, the first reflected light inputted from the third waveguide 74A and the second reflected light inputted from the fourth waveguide 74B.

The first coupling element 36A is placed on an optical path between the first splitter 32A and the photodetector 50. The first coupling element 36A is connected to the first splitter 32A via the waveguide 75 and connected to the second coupling element 36B via the waveguide 76. The first coupling element 36A sends, to the photodetector 50, interfering light generated by interference between the first reflected light sent from the second coupling element 36B and the reference light sent from the first splitter 32A and interfering light generated by interference between the second reflected light sent from the second coupling element 36B and the reference light sent from the first splitter 32A.

The photodetector 50 outputs a signal corresponding to the intensity of the interfering light. The processing circuit 60 computes, on the basis of the signal, the distance to one or more physical objects that are present in the scene and/or the velocity of the one or more physical objects.

Thus, the first irradiating light and the first reflected light reflected from the scene pass together through the first waveguide 72A. The second irradiating light and the second reflected light reflected from the scene pass together through the second waveguide 72B. The third waveguide 74A branches off from the first waveguide 72A, and the first reflected light having passed through the first waveguide 72A passes through the third waveguide 74A. The fourth waveguide 74B branches off from the second waveguide 72B, and the second reflected light having passed through the second waveguide 72B passes through the fourth waveguide 74B. The fifth waveguide 73A inputs the first irradiating light from the second splitter 32B to the first waveguide 72A. The sixth waveguide 73B inputs the second irradiating light from the second splitter 32B to the second waveguide 72B. The photodetector 50 detects the first reflected light, the second reflected light, and the reference light.

Let it be assumed that as shown in FIG. 11, d₂₁ is the optical path length of the first waveguide 72A, d₂₂ is the optical path length of the second waveguide 72B, d₄₁ is the optical path length of the third waveguide 74A, d₄₂ is the optical path length of the fourth waveguide 74B, dn is the optical path length of the fifth waveguide 73A, and d₁₂ is the optical path length of the sixth waveguide 73B. Let it be assumed that d₁ is the optical path length of the waveguide 71, that d₅ is the optical path length of the waveguide 75, and that do is the optical path length of the waveguide 76. Let it be assumed that d₃₁ is the distance from the first optical element 40A to the physical object 10A and that d₃₂ is the distance from the second optical element 40B to the physical object 10B.

It is the optical path length d₂₁ of the first waveguide 72A and the optical path length d₂₂ of the second waveguide 72B that are responsible for fiber noise. In the present embodiment, the first dividing element 39A is placed between the second splitter 32B and the first optical element 40A, and the second dividing element 39B is placed between the second splitter 32B and the second optical element 40B. This makes it possible to change total optical path lengths corresponding separately to each of the physical objects 10A and 10B by adjusting the optical path lengths du and d₄₁ and the optical path lengths d₁₂ and d₄₂. In the present embodiment, return light, if any, generated in the waveguides 73A and 74A and the waveguides 73B and 74B does not generate fiber noise, as the return light does not enter the photodetector 50. Making a difference between the total of d₁ and d₄₁ and the total of d₁₂ and d₄₂ makes it possible to divide from each other a frequency band of measurement of the distance to the first physical object 10A and a frequency band of measurement of the distance to the second physical object 10B.

Thus, in the present embodiment, the total of the optical path length du of the fifth waveguide 73A from the second splitter 32B to the first dividing element 39A and the optical path length d₄₁ of the third waveguide 74A from the first dividing element 39A to the second coupling element 36B is adjusted to be different from the total of the optical path length d₁₂ of the sixth waveguide 73B from the second splitter 32B to the second dividing element 39B and the optical path length d₄₂ of the fourth waveguide 74B from the second dividing element 39B to the second coupling element 36B. That is, in the present embodiment, Formula (10) is satisfied as follows:

$${d}_{11} + {d}_{41} \approx {d}_{12} + {d}_{42} \qquad ( 10 )$$

This makes it possible to divide from each other a band of beat frequencies of reflected light based on the first beam and a band of beat frequencies of reflected light based on the second beam, making it possible to measure the distances to and the velocities of a plurality of targets.

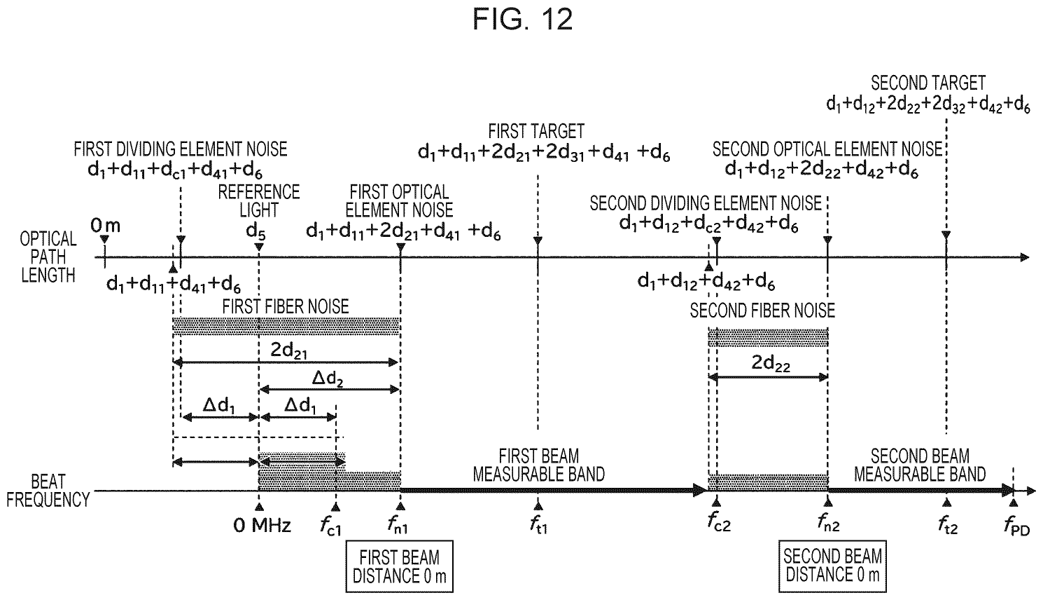

FIG. 12 is a diagram for explaining a relationship between optical path length and beat frequency and the influence of various types of noise. The optical path length here represents an optical path length starting at the first splitter 32A and ending at the first coupling element 36A. Let it be assumed that f_{PD} is the maximum value of a frequency that is able to be detected by the photodetector 50 and the processing circuit 60. Let it be assumed that fₙ₁ is the frequency at which the first optical element noise is generated, that fₙ₂ is the frequency at which the second optical element noise is generated, that f_{c1} is the frequency at which the first dividing element noise is generated, that fez is the frequency at which the second dividing element noise is generated, that fₜ₁ is a beat frequency corresponding to the first target, and that fₜ₂ is a beat frequency corresponding to the second target. When the optical path length matches the optical path length d₅ of the reference light, the beat frequency becomes 0 MHz.

The frequency fₙ₁ of the first optical element noise corresponds to a zero-meter point of measurement of the distance by the first beam. The frequency fₙ₂ of the second optical element noise corresponds to a zero-meter point of measurement of the distance by the second beam. In this example, the frequency fₙ₂ is made higher than the frequency fₙ₁ by making the optical path length d₄₂ of the waveguide 74B longer than the optical path length d₄₁ of the waveguide 74A.

The first dividing element noise is noise generated because a portion of light originally supposed to travel from the waveguide 73A toward the waveguide 72A travels toward the waveguide 74A. Let it be assumed that del is the optical path length of noise light inside the first dividing element 39A that causes the first dividing element noise. The second dividing element noise is noise generated because a portion of light originally supposed to travel from the waveguide 73B toward the waveguide 72B travels toward the waveguide 74B. Let it be assumed that d_{c2} is the optical path length of noise light inside the second dividing element 39B that causes the second dividing element noise.

Due to the round-trip optical path length 2d₂₁ of the waveguide 72A, first fiber noise is generated. Further, due to the round-trip optical path length 2d₂₂ of the waveguide 72B, second fiber noise is generated. In a band in which the first fiber noise is generated and a band in which the second fiber noise is generated, a target with a low optical reflectance cannot be measured. A first beam measurable band and a second beam measurable band, which do not overlap the bands in which the fiber noise is generated, are frequency bands in which distance measurement is possible, and distance measurement and velocity measurement are possible in distance ranges corresponding to these frequency bands. As in the case of the configuration shown in FIG. 11, shortening d₂₁ and d₂₂ makes it possible to narrow the bands in which the fiber noise is generated, thus making it possible to expand the distance-measuring ranges.

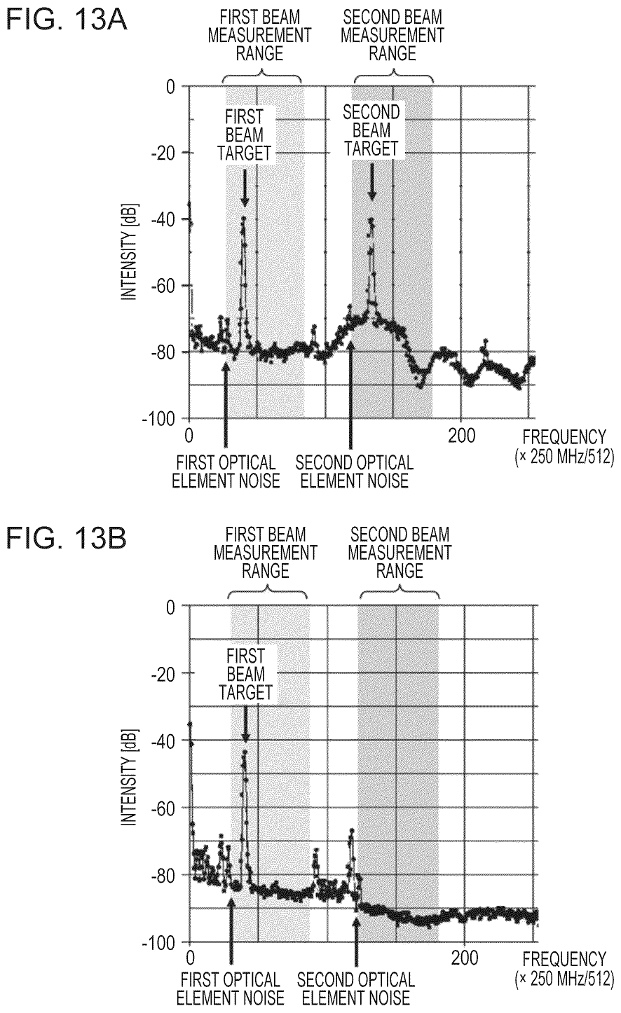

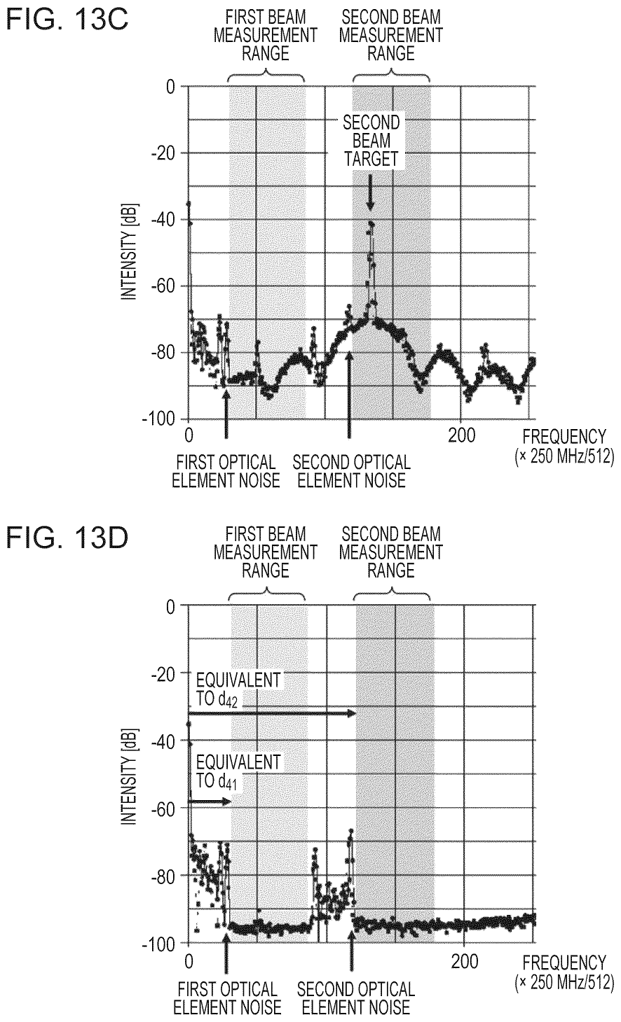

FIGS. 13A to 13D are graphs showing examples of the power spectra of beat signals in the present embodiment. FIG. 13A is a diagram showing an example of the power spectra of beat signals obtained when both the first beam and the second beam are shone on the respective targets. FIG. 13B is a diagram showing an example of the power spectra of beat signals obtained when the first beam is shone on a target and the second beam is blocked. FIG. 13C is a diagram showing an example of the power spectra of beat signals obtained when the first beam is blocked and the second beam is shone on a target. FIG. 13D is a diagram showing an example of the power spectra of beat signals obtained when both the first beam and the second beam are blocked.

In this example, the targets are pieces of Kent paper placed in locations at a distance of 1 m from the first optical element 40A and the second optical element 40B, respectively. The range of measurement with the first beam and the range of measurement with the second beam were divided from each other by configuring the settings d₁₁=d₁₂=2 m, d₂₁=2 m, and d₂₂=1 m to make a difference between d₄₁=2 m and d₄₂₌₁₂ m.

FIGS. 13B and 13C shows spectra in cases where the first beam and the second beam were blocked in front of the respective targets. As shown in FIGS. 13A to 13C, it was confirmed that reflected light from a target is detected as a clear peak frequency. Further, as shown in FIG. 13D, in a case where both beams were blocked, it was confirmed that a reduction in noise level can be achieved by clearly dividing the range of measurement with the first beam and the range of measurement with the second beam from each other and causing no fiber noise to overlap the ranges of measurement.

Although, in FIG. 11, the measurement apparatus 600B emits two beams, the measurement apparatus 600B may be configured to emit three or more beams. In that case, the second splitter 32B is configured to divide light from the waveguide 71 into three or more beams of light, and as many sets of a dividing element and an optical element as beams are added. The second coupling element 36B is configured to couple return light from as many dividing elements as beams and input the return light to the first coupling element 36A.

### Modifications

The following describes modifications of the present embodiment.

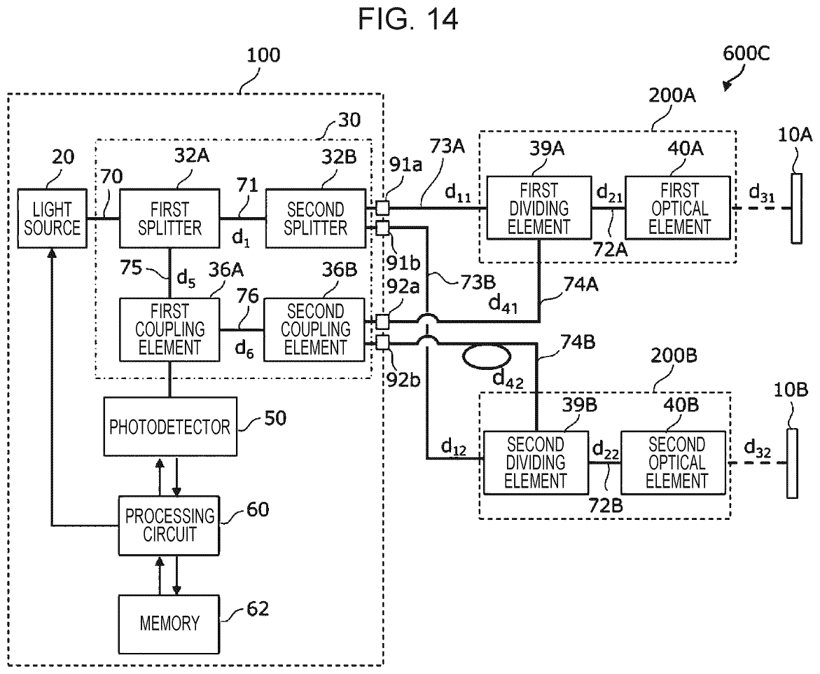

FIG. 14 is a block diagram showing a configuration of a measurement apparatus 600C according to a modification of the present embodiment. The measurement apparatus 600C according to the present modification includes a LiDAR unit 100, a first optical head 200A, and a second optical head 200B. The LiDAR unit 100 includes a light source 20, an interference optical system 30, a photodetector 50, a processing circuit 60, and a memory 62. The interference optical system 30 includes a first splitter 32A, a second splitter 32B, a first coupling element 36A, and a second coupling element 36B. The first optical head 200A includes a first dividing element 39A and a first optical element 40A. The second optical head 200B includes a second dividing element 39B and a second optical element 40B. The constituent elements of the LiDAR unit 100 and the optical heads 200A and 200B are identical to the corresponding constituent elements shown in FIG. 11.

In the case of large physical objects or in the case of physical objects having complex structures, the optical elements 40A and 40B (e.g. beam shapers) need to be placed at various positions or angles. As mentioned earlier, shortening the optical path length d₂₁ of the waveguide 72A and the optical path length d₂₂ of the waveguide 72B makes it possible to narrow the bands in which the fiber noise is generated and expand the measurable distance ranges. Accordingly, in the present modification, the first dividing element 39A and the first optical element 40A are accommodated in a housing of the first optical head 200A, and the second dividing element 39B and the second optical element 40B are accommodated in a housing of the second optical head 200B. This makes it possible to shorten the waveguides 72A and 72B and to flexibly change the positions and orientations of the optical elements 40A and 40B.

In the present modification, the housing of the LiDAR unit 100 accommodates the light source 20, the interference optical system 30, the photodetector 50, the processing circuit 60, and the memory 62. The LiDAR unit 100 includes a first outputter 91a, a second outputter 91b, a first inputter 92a, and a second inputter 92b. The fifth waveguide 73A is connected to the first outputter 91a. The sixth waveguide 73B is connected to the second outputter 91b. The third waveguide 74A is connected to the first inputter 92a. The fourth waveguide 74B is connected to the second inputter 92b. The first outputter 91a outputs the first irradiating light from the second splitter 32B to the fifth waveguide 73A. The second outputter 91b outputs the second irradiating light from the second splitter 32B to the sixth waveguide 73B. The first inputter 92a inputs the first reflected light from the third waveguide 74A to the second coupling element 36B. The second inputter 92b inputs the second reflected light from the fourth waveguide 74B to the second coupling element 36B. The outputters 91a and 91b and the inputters 92a and 92b can be achieved, for example, by two optical output ports and two optical input ports, respectively, provided in the housing of the LiDAR unit 100.

The LiDAR unit 100 may accommodate only some of the light source 20, the interference optical system 30, the photodetector 50, the processing circuit 60, and the memory 62. For example, the processing circuit 60 and the memory 62 may be provided in a device outside the LiDAR unit 100. Waveguides (e.g. the waveguides 70, 71, 75, and 76) in the LiDAR unit 100 may be optical fiber waveguides or may be formed on a chip. Such a chip may have at least one of the light source 20, the photodetector 50, the processing circuit 60, and the memory 62 integrated thereon.

The housing of the optical head 200A accommodates the first dividing element 39A, the first optical element 40A, the first waveguide 72A, part of the third waveguide 74A, and part of the fifth waveguide 73A. The housing of the optical head 200B accommodates the second dividing element 39B, the second optical element 40B, the second waveguide 72B, part of the fourth waveguide 74B, and part of the sixth waveguide 73B. Thus, the first head 200A accommodates at least part of the first waveguide 72A and at least part of the third waveguide 74A, and the second head 200B accommodates at least part of the second waveguide 72B and at least part of the fourth waveguide 74B.

By separating the optical heads 200A and 200B from the LiDAR unit 100, the optical heads 200A and 200B can be placed away from the LiDAR unit 100. This makes it possible to reduce the sizes and weights of the optical heads 200A and 200B, leading to an increase in the degree of freedom of placement of the optical heads 200A and 200B. Further, since the temperature-resistant and vibration-resistant housing of the LiDAR unit 100 accommodates a precision device such as the light source 20, the photodetector 50, or the processing circuit 60, stable operation of these precision devices can be achieved. Furthermore, improvement in the degree of freedom of design and fabrication such as chipping of the LiDAR unit 100 can be brought about.

In the present embodiment, the LiDAR unit 100 and the first optical head 200A are optically coupled to each other by the waveguides 73A and 74A. The LiDAR unit 100 and the second optical head 200B are optically coupled to each other by the waveguides 73B and 74B. The optical path length du of the waveguide 73A, the optical path length d₁₂ of the waveguide 73B, the optical path length d₄₁ of the waveguide 74A, and the optical path length d₄₂ of the waveguide 74B are not responsible for fiber noise and can be lengthened depending on how the optical path length d₅ of the waveguide 75 is adjusted. This makes it possible to separate the optical heads 200A and 200B from the LiDAR unit 100. This also makes it easy to expand the measurable distance ranges while reducing fiber noise by shortening the optical path length d₂₁ of the waveguide 72A and the optical path length d₂₂ of the waveguide 72B.

### Calibration Method

The following describes an example of a method for calibrating a measurement apparatus.

First, the optical system shown in FIG. 11 or 14 is constructed, and the physical objects are placed in locations away from the first optical element 40A and the second optical element 40B. For example, the physical objects are placed in locations at a distance of 1 m from the first optical element 40A and the second optical element 40B. As the physical objects, silver diffuser panels having a high reflectance to some degree or other objects can be used. The physical objects are placed so that reflected light from the physical objects returns to the first optical element 40A and the second optical element 40B (e.g. collimator lenses). The physical objects are irradiated with the first beam and the second beam, and the spectra of beat signals detected by the photodetector 50 are checked. n the basis of the spectra, it is confirmed that the respective fiber noise bands and the respective distance-measuring ranges do not overlap each other. In a case where a fiber noise band overlaps either of the first and second beam distance-measuring ranges, the optical path lengths d₂₁, d₂₂, and d₅ are adjusted so that the fiber noise band does not overlap either of the beam distance-measuring ranges. This makes it possible to achieve a measurement apparatus with wide distance-measuring ranges.

### CONCLUSION

The present disclosure is not limited to the aforementioned embodiments. Applications to each embodiment of various alterations conceived of by persons skilled in the art, applications to each modification of various alterations conceived of by persons skilled in the art, aspects constructed by combining constituent elements of different embodiments, aspects constructed by combining constituent elements of different modifications, aspects constructed by combining a constituent element of any embodiment and a constituent element of any modification may be encompassed in the present disclosure, as long as such applications and aspects do not depart from the scope of the present disclosure.

The foregoing description of embodiments discloses the following technologies.

### Technology 1

A measurement apparatus including:
a light source;
a first splitter that divides light from the light source into irradiating light and reference light;
a second splitter that divides the irradiating light into first irradiating light and second irradiating light;
a first waveguide through which the first irradiating light and first reflected light reflected from a scene pass together;
a second waveguide through which the second irradiating light and second reflected light reflected from the scene pass together;
a third waveguide that branches off from the first waveguide and through which the first reflected light having passed through the first waveguide passes;
a fourth waveguide that branches off from the second waveguide and through which the second reflected light having passed through the second waveguide passes; and
a photodetector that detects the first reflected light, the second reflected light, and the reference light.

This configuration makes it possible to measure the distances and/or velocities of a plurality of targets. This makes it possible, for example, to expand measurable distance ranges.

### Technology 2

The measurement apparatus according to technology 1, further including:
a fifth waveguide that inputs the first irradiating light from the second splitter to the first waveguide; and
a sixth waveguide that inputs the second irradiating light from the second splitter to the second waveguide,
wherein a total of an optical path length of the third waveguide and an optical path length of the fifth waveguide and a total of an optical path length of the fourth waveguide and an optical path length of the sixth waveguide are different from each other.

This configuration makes it possible to divide from each other a frequency band of measurement by a first beam emitted to the scene via the first waveguide and a frequency band of measurement by a second beam emitted to the scene via the second waveguide. This makes it possible to perform measurements of the plurality of targets with a higher degree of accuracy.

### Technology 3

The measurement apparatus according to technology 2, further including:
a first dividing element that outputs, to the first waveguide, the first irradiating light inputted from the fifth waveguide and that outputs, to the third waveguide, the first reflected light inputted from the first waveguide; and
a second dividing element that outputs, to the second waveguide, the second irradiating light inputted from the sixth waveguide and that outputs, to the fourth waveguide, the second reflected light inputted from the second waveguide.

### Technology 4

The measurement apparatus according to technology 3, further including:
a first coupling element placed on an optical path between the first splitter and the photodetector; and
a second coupling element that outputs, to the first coupling element, the first reflected light inputted from the third waveguide and the second reflected light inputted from the fourth waveguide,
wherein
the light source emits light whose frequency varies with time, and
the first coupling element sends, to the photodetector, interfering light generated by interference between the first reflected light and the reference light and interfering light generated by interference between the second reflected light and the reference light.

### Technology 5

The measurement apparatus according to technology 4, wherein the photodetector outputs a signal corresponding to an intensity of the interfering light,
the measurement apparatus further including a processing circuit that computes, on the basis of the signal, a distance to one or more physical objects that are present in the scene and/or a velocity of the one or more physical objects.

### Technology 6

The measurement apparatus according to any of technologies 1 to 5, further including:
a first head that accommodates at least part of the first waveguide and at least part of the third waveguide; and
a second head that accommodates at least part of the second waveguide and at least part of the fourth waveguide.

### Technology 7

The measurement apparatus according to technology 6, wherein
the first head further accommodates a first optical element that collimates the first irradiating light having propagated through the first waveguide and that emits the first irradiating light toward the scene, and
the second head further accommodates a second optical element that collimates the first irradiating light having propagated through the first waveguide and that emits the first irradiating light toward the scene.

### Technology 8

The measurement apparatus according to any of technologies 1 to 7, further including a chip having the light source, the first splitter, the second splitter, and the photodetector integrated thereon.

### Technology 9

The measurement apparatus according to technology 8, wherein the chip further has integrated thereon a processing circuit that computes, on the basis of a signal outputted from the photodetector, a distance to at least one physical object that is present in the scene and/or a velocity of the physical object.

### Technology 10

The measurement apparatus according to any of technologies 1 to 9, further including a housing that accommodates the light source, the first splitter, the second splitter, and the photodetector.

### Technology 11

The measurement apparatus according to technology 10, wherein the housing further accommodates a processing circuit that computes, on the basis of a signal outputted from the photodetector, a distance to at least one physical object that is present in the scene and/or a velocity of the physical object.

A measurement apparatus according to an embodiment of the present disclosure can be utilized for uses, for example, in a distance-measuring system that is mounted in a vehicle such as an automobile, an unmanned aerial vehicle (UAV), or an automated guided vehicle (AGV) or in vehicle detection.

What is claimed is:

1. A measurement apparatus comprising:
a light source;
a first splitter that divides light from the light source into irradiating light and reference light;
a second splitter that divides the irradiating light into first irradiating light and second irradiating light;
a first waveguide through which the first irradiating light and first reflected light reflected from a scene pass together;
a second waveguide through which the second irradiating light and second reflected light reflected from the scene pass together;
a third waveguide that branches off from the first waveguide and through which the first reflected light having passed through the first waveguide passes;
a fourth waveguide that branches off from the second waveguide and through which the second reflected light having passed through the second waveguide passes; and
a photodetector that detects the first reflected light, the second reflected light, and the reference light.

2. The measurement apparatus according to claim 1, further comprising:
a fifth waveguide that inputs the first irradiating light from the second splitter to the first waveguide; and
a sixth waveguide that inputs the second irradiating light from the second splitter to the second waveguide,
wherein a total of an optical path length of the third waveguide and an optical path length of the fifth waveguide and a total of an optical path length of the fourth waveguide and an optical path length of the sixth waveguide are different from each other.

3. The measurement apparatus according to claim 2, further comprising:
a first dividing element that outputs, to the first waveguide, the first irradiating light inputted from the fifth waveguide and that outputs, to the third waveguide, the first reflected light inputted from the first waveguide; and
a second dividing element that outputs, to the second waveguide, the second irradiating light inputted from the sixth waveguide and that outputs, to the fourth waveguide, the second reflected light inputted from the second waveguide.

4. The measurement apparatus according to claim 3, further comprising:
a first coupling element placed on an optical path between the first splitter and the photodetector; and
a second coupling element that outputs, to the first coupling element, the first reflected light inputted from the third waveguide and the second reflected light inputted from the fourth waveguide,
wherein
the light source emits light whose frequency varies with time, and
the first coupling element sends, to the photodetector, interfering light generated by interference between the first reflected light and the reference light and interfering light generated by interference between the second reflected light and the reference light.

5. The measurement apparatus according to claim 4, wherein the photodetector outputs a signal corresponding to an intensity of the interfering light,
the measurement apparatus further comprising a processing circuit that computes, on the basis of the signal, a distance to one or more physical objects that are present in the scene and/or a velocity of the one or more physical objects.

6. The measurement apparatus according to claim 1, further comprising:
a first head that accommodates at least part of the first waveguide and at least part of the third waveguide; and
a second head that accommodates at least part of the second waveguide and at least part of the fourth waveguide.

7. The measurement apparatus according to claim 6, wherein
the first head further accommodates a first optical element that collimates the first irradiating light having propagated through the first waveguide and that emits the first irradiating light toward the scene, and
the second head further accommodates a second optical element that collimates the first irradiating light having propagated through the first waveguide and that emits the first irradiating light toward the scene.

8. The measurement apparatus according to claim 1, further comprising a chip having the light source, the first splitter, the second splitter, and the photodetector integrated thereon.

9. The measurement apparatus according to claim 8, wherein the chip further has integrated thereon a processing circuit that computes, on the basis of a signal outputted from the photodetector, a distance to at least one physical object that is present in the scene and/or a velocity of the physical object.

10. The measurement apparatus according to claim 1, further comprising a housing that accommodates the light source, the first splitter, the second splitter, and the photodetector.

11. The measurement apparatus according to claim 10, wherein the housing further accommodates a processing circuit that computes, on the basis of a signal outputted from the photodetector, a distance to at least one physical object that is present in the scene and/or a velocity of the physical object.
